(19) United States
(12) Patent Application Publication
(10) Pub. No.: US 2007/0046838 A1
(43) Pub. Date: Mar. 1, 2007

(54) LCD TV structure

(75) Inventor: Steven Tsai, Taoyuan (TW)

Correspondence Address: Troxell Law Office Pllc, Suite 1404, 5205 Leesburg Pike, Falls Church, VA, 22041, US

(73) Assignee: Herlannational Co., Ltd.

(21) Appl. No.: 11/215,026

(22) Filed: Aug. 31, 2005

(51) Int. Cl. H04N 5/64

(52) U.S. Cl. 348/794

(57) ABSTRACT

An LCD TV structure is composed of a casing, a liquid crystal panel module, a power supplier, a circuit board for signal processing, and connection wires, wherein all of the connection wires of the circuit board for signal processing inside the LCD TV are connected to one or a plurality of adapters which are located at proper positions in a sliding slot at one side of the casing. In addition, the circuit board for signal processing is located in a control box which is provided with connectors corresponding to the quantity and positions of the aforementioned adapters. Accordingly, the control box can be glided and inserted into a sliding slot of the casing, such that the connectors of control box can be electrically conducted with the adapters inside the sliding slot. This discrete design can facilitate a product repairing or upgrading.

### BACKGROUND OF THE INVENTION

(a) Field of the Invention

The present invention relates to an LCD (Liquid Crystal Display) TV structure, and more particularly to an LCD TV structure with a discrete design wherein connection wires and a circuit board for signal processing inside the LCD TV are isolated, thereby facilitating a product repairing or upgrading.

(b) Description of the Prior Art

In recent years, due to a change of global environment driven by the advancement of technologies, the requirement on audio/video entertainment for an ordinary family is even pickier than before, which expects a better, larger image, and a more realistic, stereo audio effect. Accordingly, an audio/video product in a large size arises in the market, such as a conventional TV, a plasma TV, and an LCD TV. However, as the conventional TV uses a CRT (Cathode Ray Tube) as its source of image generation, the CRT will be bigger if a screen in a larger size is required. Therefore, the entire volume of TV will be correspondingly enlarged. Accordingly, the conventional TV is gradually weeded out in a competition of large screens, remaining with the more popular plasma TV and LCD TV Nevertheless, there are still some problems in a quality of image for the plasma TV, with the essential problem in the feature of pixels. As a pixel of plasma TV can only be lightened by an electric current, therefore it will be or will not be lightened without an intermediate state. Accordingly, a method called PCM (Pulse Code Modulation) will be used to control the brightness, wherein the pixels which need to be lightened will be lightened, whereas the pixels will not be lightened too often for positions requiring shadows. An effect of different brightness can be generated by automatically sampling at regular time interval. However, there are other problems, such as that a pulsation of screen will make a user uncomfortable if he or she is too close to a panel, the screen is also provided with the problem of burn-in, or aging of the pixels, and the manufacturing cost of control elements is too high. Finally, for the large LCD TV which is more accepted by a general public, the LCD TV is generally cheaper than the plasma TV, and the brightness of an LCD is better than that of a CRT in terms of the quality of image. In addition, the pixel of LCD will not be pulsating. Therefore, the LCD TV is provided with a great image stability, which means that you can watch in a close distance without worrying that the eyes will be fatigued. Moreover, the brightness of LCD TV is excellent, and the image is very sharp without too much problems of burn-in. In general, the LCD TV uses a principle that a liquid crystal will be lightened to generate an image under an effect of electric potential. The liquid crystals which constitute a screen are divided into three primary colors of red, green, and blue, and are sorted by a certain order. By stimulating these liquid crystals through the electric potential, different colors can be manifested. Moreover, versatile colors can be manifested associated with a various proportion. Referring to FIG. 1, an LCD TV a includes a casing a1, a liquid crystal panel module a2, a power supplier a3, a circuit board a4 for signal processing, and connection wires a5, wherein the circuit board a4 for signal processing is provided with a function of image processing. Usually in assembling, the liquid crystal panel module a2 is installed in a front of the casing a1, whereas the power supplier a3 and the circuit board a4 for signal processing are installed inside the casing a1 (power suppliers for a TV below 21″ are plugged in). Accordingly, if the LCD TV a needs to be repaired or upgraded, the entire machine should be carried to a repairing place, which is very inconvenient and thereby requiring an improvement.

### SUMMARY OF THE INVENTION

The primary object of the present invention is to provide an LCD TV structure with a discrete design wherein a casing and a controlling circuit board are isolated, thereby facilitating a product repairing or upgrading.

Accordingly, the present invention comprises primarily a casing, a circuit board for signal processing, and connection wires. First of all, all of the connection wires of the circuit board for signal processing are connected to one or a plurality of adapters which are located at proper positions inside a sliding slot at one side of the casing. In addition, the circuit board for signal processing is located in a control box which is provided with connectors corresponding to the quantity and positions of the aforementioned adapters.

In using the aforementioned structure, the control box is directly glided and inserted into the sliding slot at the side of the casing, such that the connectors of the control box can be electrically conducted with the adapters in the sliding slot, which enables a conduction between the circuit board for signal processing and the internal connection wires, thereby allowing the LCD TV to be functioning normally. If a product repairing or upgrading is needed, the control box can just be disassembled and delivered to a specific repairing place for repairing or upgrading, thereby saving a trouble in carrying and facilitating a disassembling/assembling.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional LCD TV.

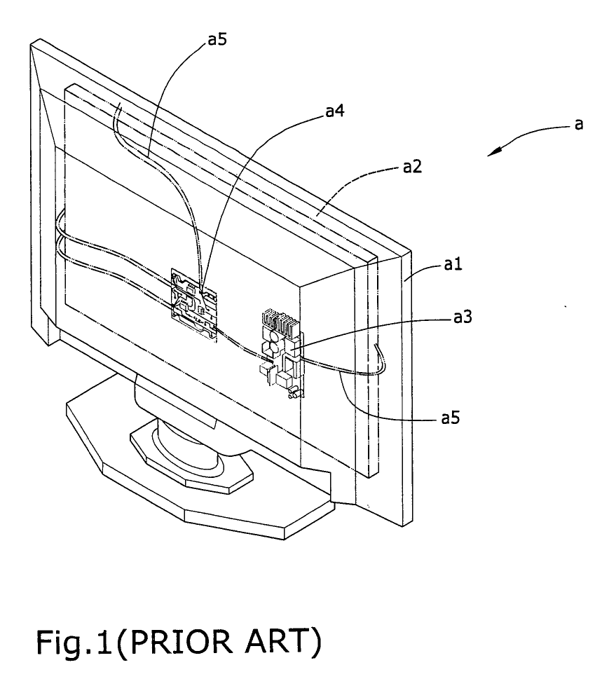

FIG. 2 shows a perspective view of the present invention.

FIG. 3 shows a cutaway view of the present invention.

### DETAILED DESCRIPTION OF THE PREFERRED EMBODIMENTS

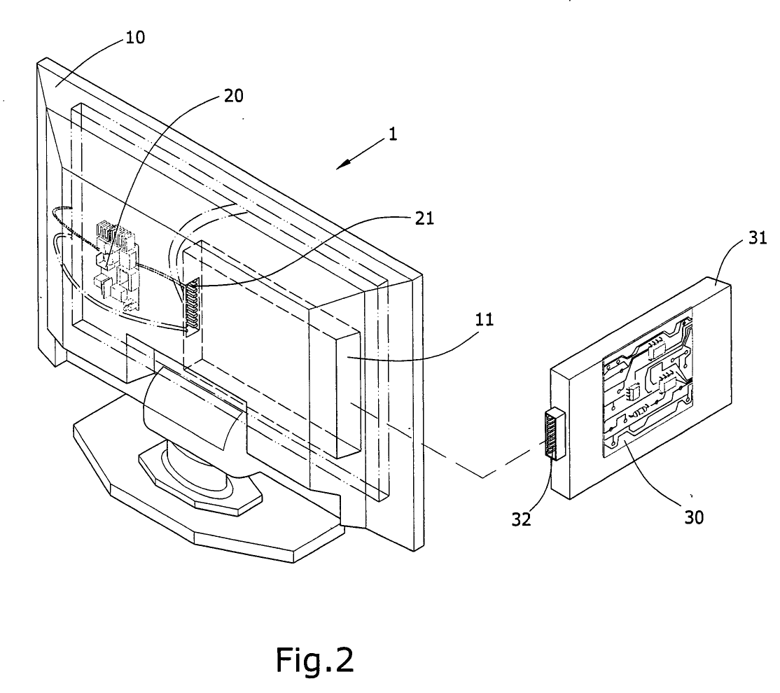

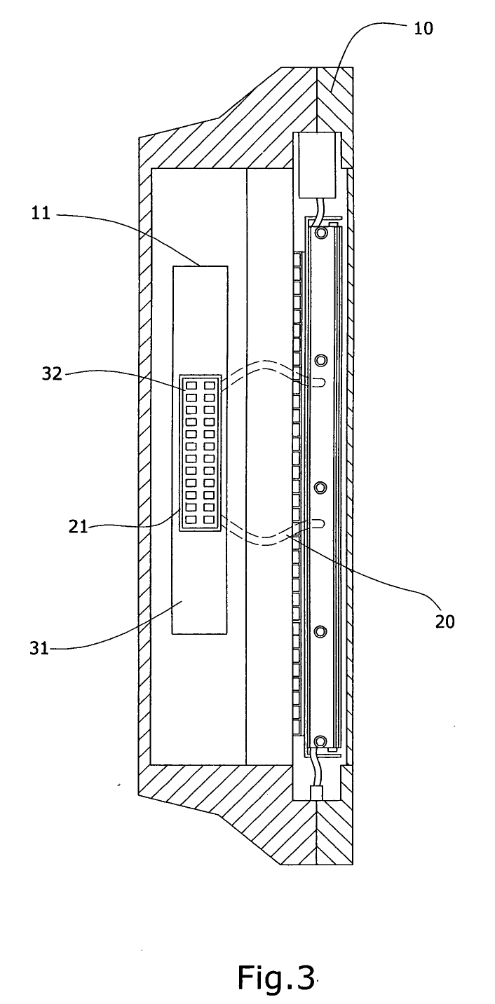

Referring to FIG. 2 and FIG. 3, the present invention comprises primarily a casing 10, connection wires 20 of an LCD TV 1, and a circuit board 30 for signal processing. First of all, all of the connection wires 20 inside the LCD TV 1 are connected to one or a plurality of adapters 21 which are located at proper positions inside a sliding slot 11 at one side of the casing 10. In addition, the circuit board 30 for signal processing is located in a control box 31 whose one side is provided with connectors 32 corresponding to the quantity and positions of the aforementioned adapters 21 inside the sliding slot 11.

When using, the control box 31 is directly glided and inserted into the sliding slot 11 at the side of the casing 10, such that the connectors 32 of the control box 31 can be electrically conducted with the adapters 21 in the sliding slot 11, Which enables a conduction between the circuit board 30 for signal processing and the connection wires 20, thereby allowing the LCD TV 1 to be functioning normally.

Accordingly, in the present invention, the connection wires are located inside the casing, and the circuit board for signal processing is located in the control box. This discrete design can facilitate a product repairing or upgrading, which is provided with a practicability and advancement.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LCD TV structure comprising a casing, a liquid crystal panel module, a power supplier, a circuit board for signal processing, and connection wires, wherein all of the connection wires of the circuit board for signal processing inside the LCD TV are connected to an adapter which is located at a proper position in a sliding slot at one side of the casing, and the circuit board for signal processing is located in a control box which is provided with a connector corresponding to the position of the aforementioned adapter.

2. An LCD TV structure comprising a casing, a liquid crystal panel module, a power supplier, a circuit board for signal processing, and connection wires, wherein all of the connection wires of the circuit board for signal processing inside the LCD TV are connected to a plurality of adapters which are located at proper positions in a sliding slot at one side of the casing, and the circuit board for signal processing is located in a control box which is provided with connectors corresponding to the quantity and positions of the aforementioned adapters.
